(19) United States
(12) Patent Application Publication
(10) Pub. No.: US 2026/0210172 A1
(43) Pub. Date: Jul. 23, 2026

(54) SERVICEABLE RETROFIT CAVITY SYSTEM WITH ACTIVE GAS MANAGEMENT

(71) Applicant: Michal Gandy, Niles, IL (US)

(72) Inventor: Michal Gandy, Niles, IL (US)

(21) Appl. No.: 19/455,456

(22) Filed: Jan. 21, 2026

Related U.S. Application Data
(60) Provisional application No. 63/748,180, filed on Jan. 22, 2025.

(51) Int. Cl. E06B 3/66; E06B 3/663

(52) U.S. Cl. CPC E06B 3/6621; E06B 3/66347; E06B 3/66352

(57) ABSTRACT

A retrofit cavity system for installation in a window frame having a glass pane is provided. The retrofit cavity system includes an Insulated Glass Unit (IGU), glass-IGU spacer, and a gas transit nozzle. The glass-IGU spacer is adhered along a first side near the perimeter of an exterior-facing glass pane of the IGU. The gas transit nozzle extends though said glass-IGU spacer and including a cavity aperture positioned inside a perimeter described by said glass-IGU spacer and a service aperture positioned proximal to an interior-facing glass pane of said IGU. The glass-IGU spacer is then adhered to the glass pane of the window frame to form an interior cavity between the glass pane of the window frame, the exterior-facing glass pane of the IGU and the said glass-IGU spacer. The gas transit nozzle allows gas to be moved into or out of the interior cavity.

### CROSS-REFERENCE TO RELATED APPLICATIONS

The present application claims the benefit of U.S. Provisional Application No. 63/748,180, filed Jan. 22, 2025, entitled “System And Method For Window Conversion”, which is hereby incorporated by reference in its entirety.

### BACKGROUND OF THE INVENTION

The present invention generally relates to a system for retrofitting a window. More particularly, the present invention relates to a retrofitting system for a window with active gas management.

Single-pane windows including a window frame supporting a single pane of glass have been in use for decades. However, single-pane windows provide relatively low thermal insulation, which makes them energy inefficient, expensive, and environmentally less desirable.

In response, efforts have been made to attempt to retrofit single-pane windows to include their thermal insulation. These efforts may include attempting to position an additional pane of glass in the window to transition the single-pane window to a double-pane or triple-pane window. However, such efforts rarely produce results that are acceptable to consumers for a variety of reasons.

One reason why such efforts are unsatisfactory is that they usually result in condensation occurring between the original single-pane window and the additional pane that is attempting to be retrofitted. The condensation typically occurs due to moist air that is trapped between the old and new pane and the interaction of the moist air with temperature differences between the old and new glass panes. The condensation typically obscures the view of the consumer rendering the window aesthetically unpleasing and limiting the light transmission through the window.

### BRIEF SUMMARY OF THE INVENTION

One or more of the embodiments of the present invention provide a serviceable retrofit cavity system with active gas management for installation in a window frame having a glass pane. The retrofit cavity system includes an Insulated Glass Unit (IGU) including an exterior-facing glass pane, an interior-facing glass pane and a spacer separating the glass panes. A glass-IGU spacer is adhered to the IGU along one side near the perimeter of the exterior-facing glass pane of said IGU and then adhered to the glass pane of the window frame to describe an interior cavity between the glass pane of the window frame, the exterior-facing glass pane of the IGU and the perimeter described by the glass-IGU spacer. The glass-IGU spacer includes a gas transit nozzle having a cavity aperture that extends into the interior cavity and is in fluid/gas communication with a service aperture positioned near the interior-facing glass pane of the IGU. The gas transit nozzle allows the gas in the interior cavity to be replaced or modified as desired, for example for moisture to be removed or for air to be replaced with a stable gas such as argon or krypton. This minimizes or eliminates undesirable condensation between the glass pane of the window frame and the IGU.

### BRIEF DESCRIPTION OF THE DRAWINGS

FIG. 1 illustrates an exploded cutaway view of a serviceable retrofit cavity system with active gas management according to a preferred embodiment of the invention.

FIG. 2 illustrates an assembled cutaway view of the serviceable retrofit cavity system with active gas management of FIG. 1 according to a preferred embodiment of the invention.

FIG. 3 illustrates a view of the assembled serviceable retrofit cavity system with active gas management of FIG. 2 according to a preferred embodiment of the invention.

FIG. 4 illustrates the assembled serviceable retrofit cavity system of FIG. 3 with the finishing trim and exterior sealant tape removed.

FIG. 5 shows the preexisting window frame having a single glass pane with the interior sealant tape installed.

FIG. 6 illustrates the removal of the protective film from the interior sealant tape and the application of the interior pane sealant.

FIG. 7 shows a perspective view of the glass-IGU spacer from the side that will be adhered to the IGU.

FIG. 8 shows a perspective view of the glass-IGU spacer from the side including the cavity aperture.

FIG. 9 shows a perspective view of the glass-IGU spacer from the side opposite FIG. 7.

FIG. 10 shows a side view of the glass-IGU spacer from the side that will be adhered to the IGU.

FIG. 11 shows a perspective view of the glass-IGU spacer adhered to the IGU from a side of the glass-IGU spacer including a gas transit nozzle.

FIG. 12 shows a perspective view of the glass-IGU spacer adhered to the IGU from a corner.

FIG. 13 shows a perspective view of the glass-IGU spacer adhered to the IGU from the interior of the glass-IGU spacer that will form part of the interior cavity once assembly is completed.

FIG. 14 shows the installation of the exterior IGU sealant at the junction, contact point, or intersection of the glass-IGU spacer and the IGU.

FIG. 15 shows a perspective view of the interior side of the IGU and window frame.

FIG. 16 shows a perspective view down a first side of the perimeter channel showing a first gas transit nozzle.

FIG. 17 shows a perspective view down a second, opposite side of the perimeter channel showing a second gas transit nozzle.

FIG. 18 illustrates the installation of the desiccant in the perimeter channel and the partial installation of the exterior sealant tape.

FIG. 19 illustrates the complete installation of the exterior sealant tape.

FIG. 20 illustrates the interior side of the retrofit cavity system with the finishing trim installed.

FIG. 21 illustrates the interior side of the retrofit cavity system with finishing trim sealant being applied.

FIG. 22 illustrates the interior side of the retrofit cavity system with an optional IGU-finishing trim sealant being applied.

FIG. 23 illustrates the interior side of the fully assembled retrofit cavity system.

### DETAILED DESCRIPTION OF THE INVENTION

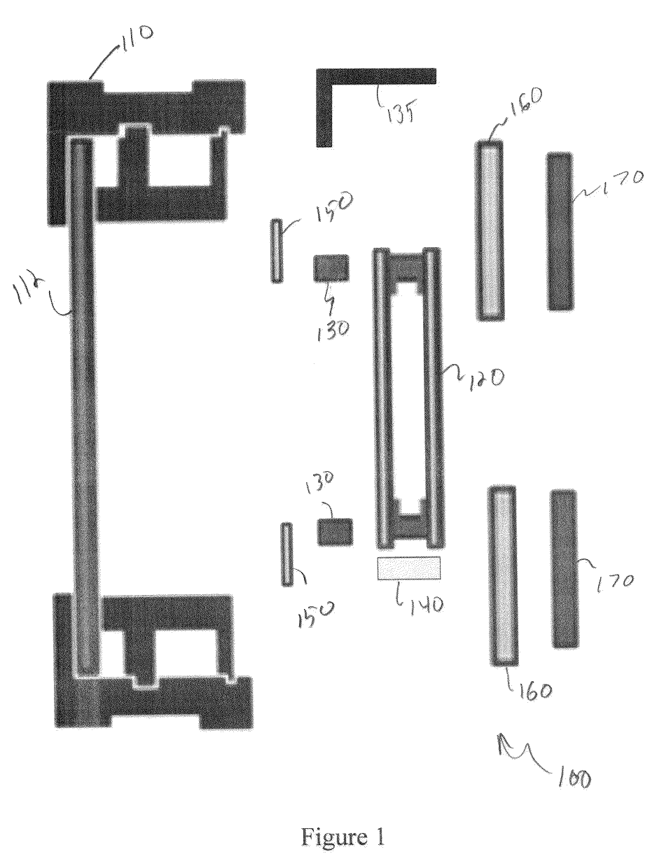

FIG. 1 illustrates an exploded cutaway view of a serviceable retrofit cavity system with active gas management 100 according to a preferred embodiment of the invention. As shown in FIG. 1, the retrofit cavity system 100 includes a preexisting window frame 110 having a single glass pane 112, an Insulated Glass Unit (IGU) 120, a glass-IGU spacer 130, a gas transit nozzle 135, a support block 140, interior sealant tape 150, exterior sealant tape 160, and finishing trim 170. The components of FIG. 1 are not to scale.

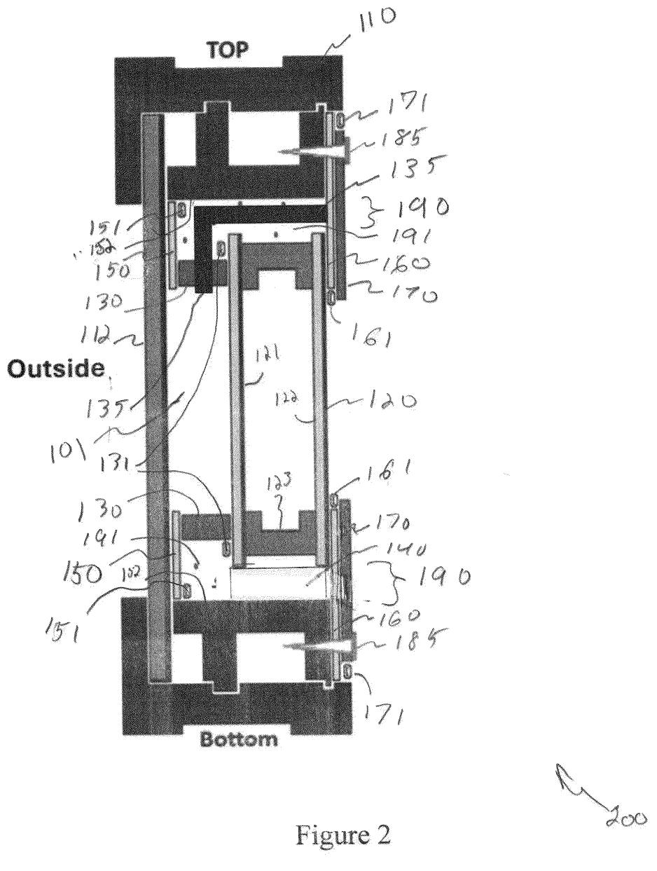

FIG. 2 illustrates an assembled cutaway view 200 of the serviceable retrofit cavity system with active gas management of FIG. 1 according to a preferred embodiment of the invention. As shown in FIG. 2, the retrofit cavity system 100 includes a preexisting window frame 110 having a single glass pane 112, an Insulated Glass Unit (IGU) 120, a glass-IGU spacer 130, a gas transit nozzle 135, a support block 140, interior sealant tape 150, exterior sealant tape 160, and finishing trim 170 as shown in FIG. 1.

FIG. 2 also includes sealed cavity 101, interior pane sealant 151, interior side surface 152 of the window frame, an exterior IGU sealant 131, an interior IGU sealant 161, a finishing trim sealant 171, mounting screws 185, a perimeter channel 190, and desiccant 191.

In one embodiment, the window frame 110 is a preexisting aluminum framed window. As described below the retrofit cavity system 100 allows the addition of a thermal-insulated glass unit (IGU), securely attached to the interior side of the original single-pane configuration, effectively transforming the window frame into a triple-pane glass unit.

The IGU may include an exterior-facing glass pane 121, an interior-facing glass pane 122, and a spacer 123 positioned near the perimeter of the exterior-facing glass pane and interior-facing glass panel to separate the panes. In one embodiment, the spacer is a Super Spacer®, a high-performance, all-foam, non-metal spacer system used in insulating glass units (IGUs) that significantly reduces heat transfer, boosts energy efficiency, and prevents condensation, blocks heat flow, and resists thermal bridging better than traditional metal spacers. The Super Spacer® is made from polymer foam with a triple-seal design, it maintains structural integrity, offers superior gas retention (for example with Argon). Traditional metal spacers may alternately be employed.

In one embodiment, the glass-IGU spacer 130 is an EdgeTech SuperSpacer®.

In one embodiment, the interior sealant tape 150 and exterior sealant tape 160 are a rubber double-sided tape sealant, for example a butyl tape sealant.

In one embodiment, the finishing trim 170 may be made of one or a combination of aluminum, metal, vinyl, or a composite.

In one embodiment, the mounting screws may be made of a metal such as stainless steel.

In one embodiment, the interior pane sealant 151, exterior IGU sealant 131, interior IGU sealant 161, and finishing trim sealant 171 may be a liquid sealant such as caulking, silicone, or butyl.

In one embodiment, the support block 140 may be composed of a deformable, non-thermally conductive material such as rubber or plastic.

In one embodiment, the gas transit nozzle 135 may be made of rubber of plastic.

As further described below, the retrofit cavity system 100 forms a sealed cavity between an existing glazing pane and a newly added glazing unit, without removing the original pane. The cavity is intentionally designed to be serviced after installation using a spacer-integrated dual conduit system which includes a spacer/seal assembly including at least two conduits. In one embodiment, one conduit may be used for gas injection and one conduit may be used for gas evacuation or forming a vacuum. As described below, the conduits are embedded in the spacer, not separate valves or factory IGU ports. Additionally, the conduit openings are positioned flush with the interior-facing surface of the added glazing for later access.

As further described below, after installation of the retrofit cavity system 100, post-installation gas exchange and moisture recovery may be performed. More specifically, after installation, the exterior sealant tape 160 may be removed to access the conduits, to allow the evacuation of moisture-containing gas, and/or to introduce dry air or inert gas. The exterior sealant tape 160 may then be repositioned to seal the retrofit cavity system 100. The ability of the retrofit cavity system 100 to allow gas between the glass pane 112 and IGU 120 to be purged and refilled and then resealed causes the retrofit cavity system 100 to be reserviceable, an advantage not provided by prior art systems.

Additionally, the retrofit cavity system 100 includes a perimeter channel between the window frame 110 and IGU 120 that provided several functions. First, the perimeter channel prevents direct glass-to-metal contact between the window frame 110 and IGU 120 to increase thermal isolation. Second, the perimeter channel houses or includes or is filled with a desiccant that may absorb moisture in order to prevent condensation between the glass pane 112 and the IGU 120. Third, the perimeter channel allows passage of the conduit system to allow gas transfer from the volume/area between the glass pane 112 and the IGU 120 to the exterior of the retrofit cavity system 100. This allows the retrofit cavity system 100 to be serviced after installation using the included conduits.

To assemble the serviceable retrofit cavity system 100, the interior sealant tape 150 is first applied to the interior side of the single glass pane 112.

Next, turning to the IGU 120, the glass-IGU spacer 130 is applied to and adhered to the exterior-facing glass pane of the IGU 120. The glass-IGU spacer 130 includes the gas transit nozzle 135. The exterior IGU sealant 131 may then be applied at the junction, contact point, or intersection of the glass-IGU spacer 130 and the IGU 120.

Next, the interior sealant tape 150, which may be a double-sided tape, may have its adhesive protective strip peeled away to expose the adhesive facing inwardly. Next, the interior pane sealant 151 is applied at the contact point between the interior sealant tape 150 and the interior surface of the window frame 110, for example to reduce thermal conductivity and/or any air leakage.

The lower edge of the IGU 120 is then placed on top of the support block 140. The height of the support block 140 has been selected to be at large enough so that the desired perimeter channel 190 around the IGU is formed.

Then, the surface of the glass-IGU spacer 130 facing away from the IGU 120 may be placed in contact with and adhere to the interior sealant tape 150 in order to adhere the IGU 120 to the glass pane 112. Once the IGU 120 is adhered to the glass pane 112, the sealed cavity 101 is formed. The sealed cavity 101 is preferably airtight except for the gas transit nozzle 135. The gas transit nozzle 135 may be sealed to render the airtight cavity airtight, but may also be unsealed to allow gas to pass into or out of the sealed cavity 101. In one embodiment, the gas transit nozzle 135 is sealed with a mechanical plug. In another embodiment, the gas transit nozzle 135 is sealed with an adhesive strip, such as the exterior sealant tape 160. As further described below, in a preferred embodiment, at least two gas transit nozzles are placed in the glass-IGU spacer 130.

Because the height and width of the IGU 120 is less than the interior height and width of the preexisting window frame 110, there is a gap around the perimeter of the IGU 120 between the exterior side edge of the IGU and the interior side surface 152 of the window frame which describes the perimeter channel 190.

The perimeter channel 190 is then filled with a desiccant. The addition of the desiccant helps to reduce moisture and reduce thermal bridging between the exterior side edge of the IGU and the interior side surface 152 of the window frame.

Next, the exterior sealant tape 170 is adhered to the interior surface of the IGU 120, extends over the perimeter channel 190 and is adhered to the interior surface of the window frame 110. Additionally, the interior IGU sealant 161 is placed at the junction, contact point, or intersection between the interior surface of the IGU 120 and the exterior sealant tape 160 and the finishing trim 170, for example to reduce thermal conductivity and/or any air leakage.

Then the finishing trim 170 is positioned around the perimeter of the IGU 120 on top of the exterior sealant tape 170. The finishing trim 170 is affixed to the window frame 110 using mounting screws 185. Additionally, the finishing trim sealant 171 is placed at the junction, contact point, or intersection between the interior surface of the exterior sealant tape 180, finishing trim 170, and window frame 110, for example to reduce thermal conductivity and/or any air leakage.

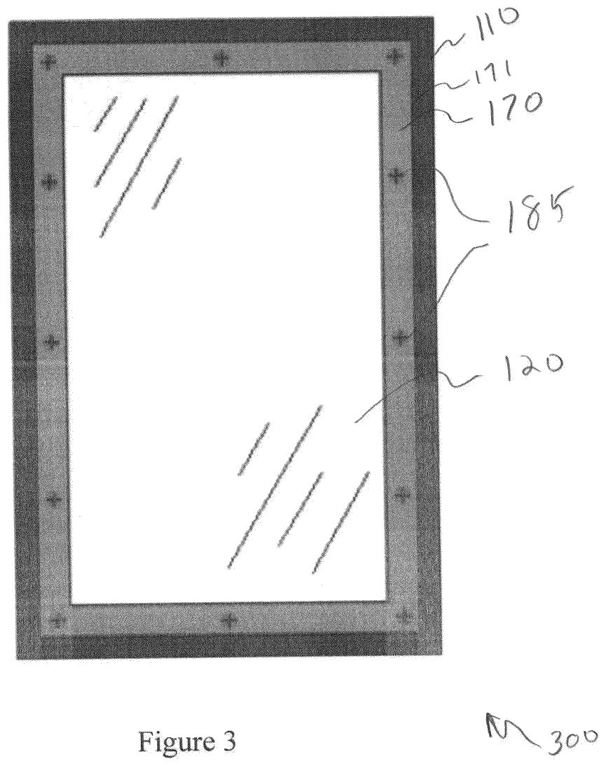

FIG. 3 illustrates a view of the assembled serviceable retrofit cavity system with active gas management of FIG. 2 according to a preferred embodiment of the invention. FIG. 3 shows the window frame 110, the finishing trim 170, the finishing trim sealant 171, twelve mounting screws 185 positioned around the perimeter of the finishing trim 170, and the interior surface of the IGU 120.

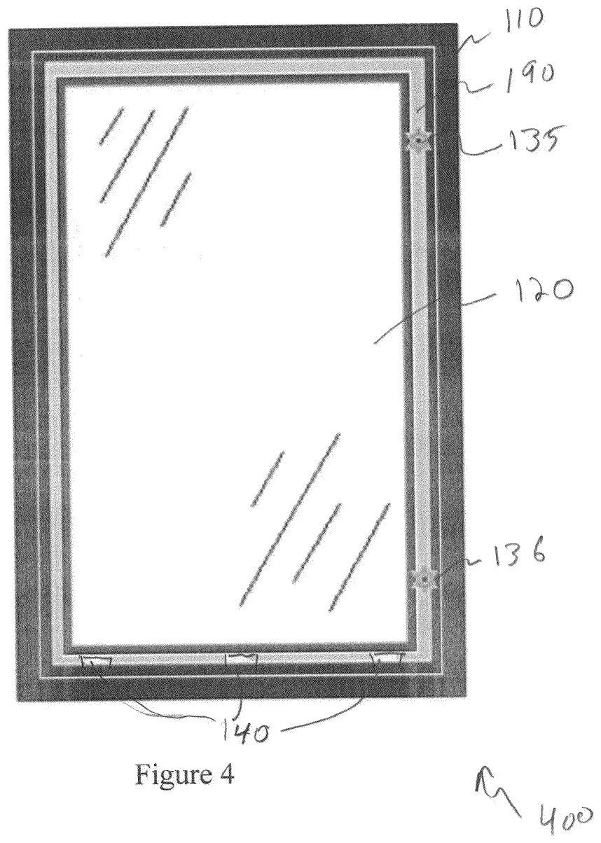

FIG. 4 illustrates the assembled serviceable retrofit cavity system of FIG. 3 with the finishing trim 170 and exterior sealant tape 160 removed. FIG. 4 shows the window frame 110, the interior surface of the IGU 120, the perimeter channel 190 filled with a desiccant, a first gas transit nozzle 135, a second gas transit nozzle 136, and three support blocks 140. As described above, the gas transit nozzles 135, 136 may be unsealed to allow gas to be passed into and/or out of the sealed cavity 101. The gas transit nozzles 135, 136 may be tubes that include a first aperture, which may be called a cavity aperture, located in the sealed cavity 101, and a second aperture, which may be called the a service aperture, located on the interior side of the retrofit cavity system 100 in the perimeter channel 190 underneath the finishing trim 170 and exterior sealant tape 160.

In operation, after the retrofit cavity system 100 has been installed, the gas in the sealed cavity 101 may be serviced by adding or removing gas through the gas transit nozzles 135, 136 once the finishing trim 170 and exterior sealant tape 160 have been removed and the gas nozzles unsealed.

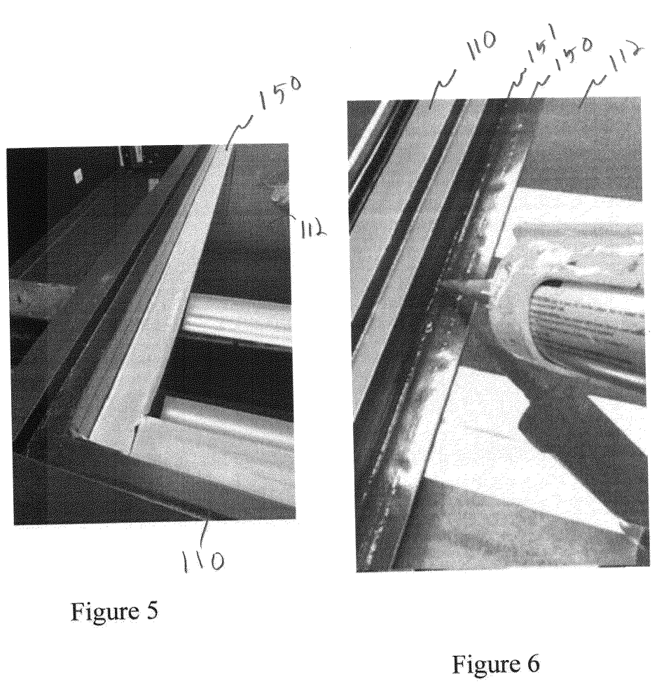

FIGS. 5-23 illustrate an exemplary assembly of the serviceable retrofit cavity system with active gas management 100 according to a preferred embodiment of the invention.

FIG. 5 shows the preexisting window frame 110 having a single glass pane 112 with the interior sealant tape 150 installed. In FIG. 5, the interior sealant tape 150 is a butyl double sided tape applied on the interior-facing surface of the single glass pane 112 or panel. The tape is applied around the perimeter of the glass pane 112 at the junction, corner, or intersection glass pane 112 and the aluminum frame 110. As further described below, the interior sealant tape 150 is the base for the IGU 120 or new glass spacer to be attached to the window frame 110. The interior sealant tape 150 is originally configured to have a protective paper film on both sides. First, the film is removed from one side of the tape to expose the adhesive and then the tape is pressed to the glass pane 112 to adhere the tape to the pane. The film on the other side of the tape is not yet removed in FIG. 5, but will be peeled off right before the glass-IGO spacer 130 is applied to the tape and adheres to the tape.

FIG. 6 illustrates the removal of the protective film from the interior sealant tape 150 and the application of the interior pane sealant 151. As shown in FIG. 6, the protective film has been removed from the side of the interior sealant tape 150 facing away from the glass pane 112 in order to expose the adhesive. Additionally, the interior pane sealant is shown being applied to the junction, intersection, contact point, or corner between the interior sealant tape 150 and the interior side surface of the window frame 110. The interior pane sealant 151 is preferably applied around the entire perimeter of the window at the junction between the interior sealant tape 150 and the interior side surface of the window frame 110. For the optimal seal protection, liquid rubber or butyl or hybrid sealant is applied in the corner between the butyl tape and the aluminum frame, for example to make the corner airtight.

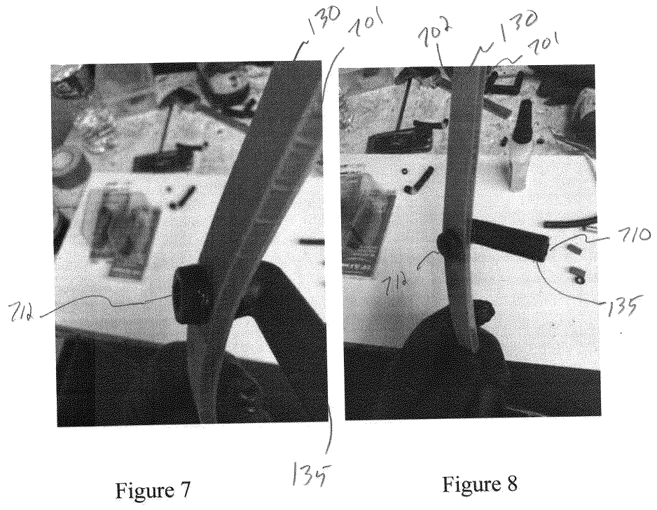

FIGS. 7-10 illustrate several views of the glass-IGU spacer 130 including the gas transit nozzle 135. FIG. 7-10 also show the glass-IGU spacer side that will be adhered to the IGU 701 and the glass-IGU spacer side that will be adhered to the glass pane 701. Additionally, with regard to the gas transit nozzle 135, FIGS. 7-10 show the first aperture, which may be called a cavity aperture 712, that will be located in the sealed cavity 101 when assembly is complete, and a second aperture, which may be called the a service aperture 710, that will be located on the interior side of the retrofit cavity system 100 in the perimeter channel 190 underneath the finishing trim 170 and exterior sealant tape 160 when assembly is complete.

FIG. 7 shows a perspective view of the glass-IGU spacer 130 from the side that will be adhered to the IGU.

FIG. 8 shows a perspective view of the glass-IGU spacer 130 from the side including the cavity aperture 712.

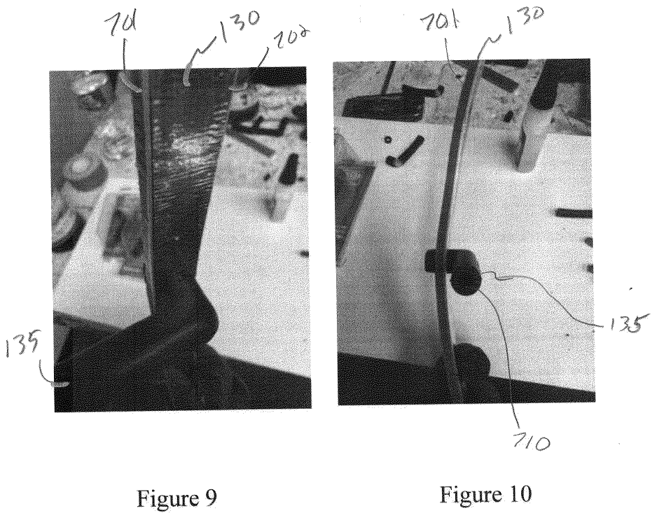

FIG. 9 shows a perspective view of the glass-IGU spacer 130 from the side opposite FIG. 7.

FIG. 10 shows a side view of the glass-IGU spacer 130 from the side that will be adhered to the IGU.

In one embodiment, the glass-IGU spacer 130 is a non-metal glass spacer with a rubber or plastic tubing comprising the gas transit nozzle 135. The gas transit nozzle 135 is angled or L-shaped so that the service aperture 710 will be accessible for gas injectors to be inserted. The glass-IGU spacer 130 has a hole punched in it that matches the diameter of the rubber tubing comprising the gas transit nozzle 135. Additionally, the perimeter of the hole in the glass-IGU spacer 130 may be sealed with a liquid rubber or butyl or hybrid sealant to further increase airtightness.

In one embodiment, two gas transit nozzles 135 are included in the assembly of the serviceable retrofit cavity system with active gas management 100. In this embodiment. These gas transit nozzles 135 allow for the replacement of the air in the interior cavity 101 between the original single glass pane 112 of the aluminum frame and the added IGU 120. The air may be replaced for example with dry air or other gasses such as argon or krypton or a vacuum. Additionally, one of the gas transit nozzles 135 may serve as the exhaust and one may serve as a vacuum. Alternatively, replacement gas may flow through a first gas transit nozzle 135 while the gas that was occupying the interior cavity 101 is evacuated by flowing outward through the other gas transit nozzle 135.

In an alternative embodiment, one gas transit nozzle 135 may be employed. In other embodiments, three or more gas transit nozzles 135 may be employed. Additionally, in embodiment where two gas transit nozzles 135 are employed, the gas transit nozzles 135 may be positioned along the same side of the IGU 120 as shown in the embodiment of FIG. 4. Alternatively, the gas transit nozzles 135 may be positioned in along different sides of the IGU 120 as further illustrated below.

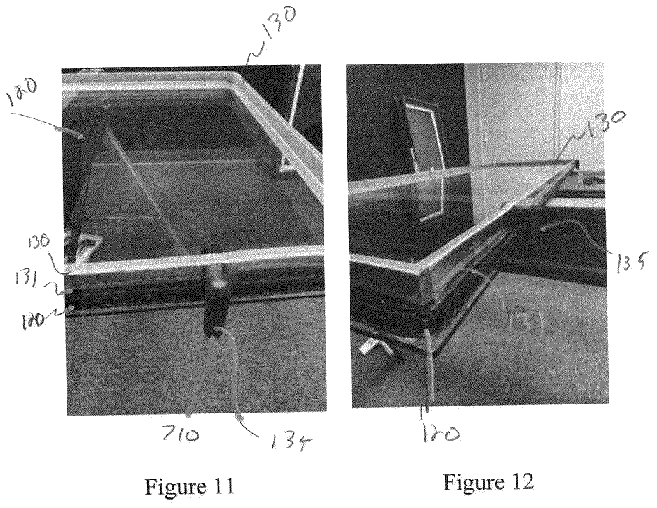

FIG. 11-14 show the glass-IGU spacer 130 adhered to the IGU 120. As shown in FIGS. 11-14, the glass-IGU spacer 130 has been adhered to the IGU 120 along one side of the glass-IGU spacer 130 around the perimeter of what will be the exterior-facing surface of the IGU 120 once assembly is complete. The gas transit nozzle 135 is shown with the service aperture 710 angled back toward what will be the interior side of the IGU 120 once assembly is complete. The cavity aperture 712 is shown to open into the interior surface of the glass-IGU spacer 130 that will be positioned in the interior cavity 101 once assembly is complete. Also shown is the exterior IGU sealant 131 applied at the junction, contact point, or intersection of the glass-IGU spacer 130 and the IGU 120.

FIG. 11 shows a perspective view of the glass-IGU spacer 130 adhered to the IGU 120 from a side of the glass-IGU spacer 130 including a gas transit nozzle 135.

FIG. 12 shows a perspective view of the glass-IGU spacer 130 adhered to the IGU 120 from a corner. As shown in FIG. 12, the glass-IGU spacer 130 may be composed of a series of four straight pieces, each installed near on edge of the IGU 120, the individual pieced of the glass-IGU spacer 130 may then be adhered together at their corners as shown to form an airtight seal. In an alternative embodiment, the glass-IGU spacer 130 is a single rectangular piece sized to match the perimeter of the IGU 120.

In one embodiment, the glass-IGU spacer 130 is adhered to the IGU 120 using a liquid sealant such as caulking, silicone, or butyl. Additionally, the exterior IGU sealant 131 may be a liquid sealant such as caulking, silicone, or butyl.

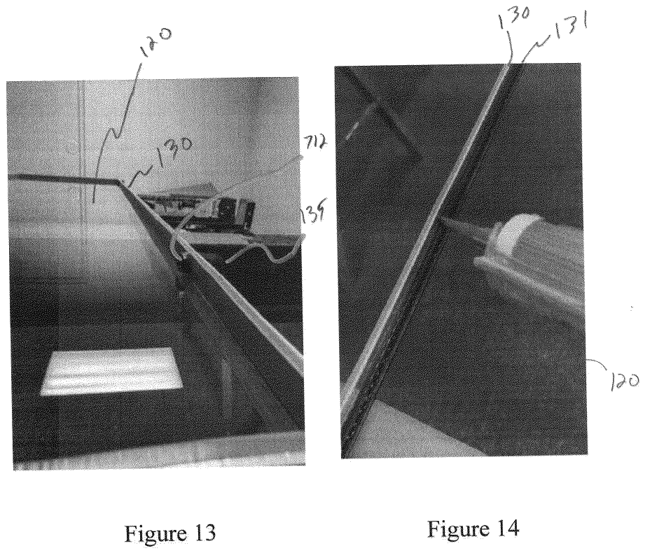

FIG. 13 shows a perspective view of the glass-IGU spacer 130 adhered to the IGU 120 from the interior of the glass-IGU spacer 130 that will form part of the interior cavity 101 once assembly is completed. The cavity aperture 712 of the gas transit nozzle 135 is shown.

FIG. 14 shows the installation of the exterior IGU sealant 131 at the junction, contact point, or intersection of the glass-IGU spacer 130 and the IGU 120.

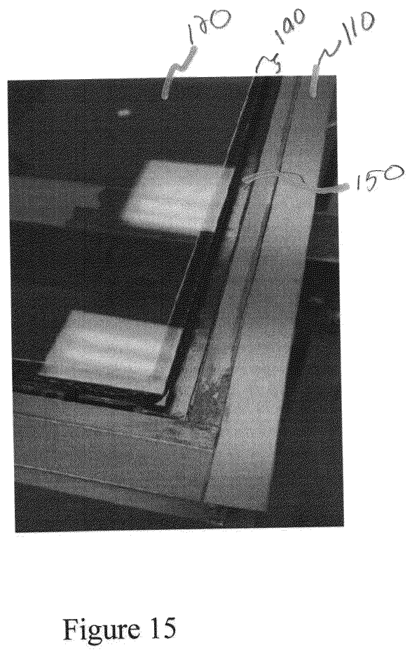

FIGS. 15-17 illustrate the installation of the IGU 120 including the glass-IGU spacer 130 into the window frame 110. In FIGS. 15-17, the window frame is positioned in the same position shown in FIG. 6 with the interior sealant tape 150 adhesive exposed. The IGU 120 including the glass-IGU spacer 130 is then inverted from the position shown in FIG. 11, so that the side of the glass-IGU spacer 130 that is not already adhered to the IGU 120 is oriented downward. Next, the side of the glass-IGU spacer 130 that is not already adhered to the IGU 120 is pressed against and adheres to the interior sealant tape 150 to bond the IGU 120 to the interior sealant tape 150 that is already adhered to the interior surface of the glass pane 112, thus adhering the IGU 120 to the glass pane 112. The bond formed by the interior sealant tape 150 is airtight.

FIG. 15 shows a perspective view of the interior side of the IGU 120 and window frame 110. Also, because the height and width of the exterior sides of the IGU is less than the height and width of the interior sides of the window frame and the IGU is positioned in the center of the sides of the window frame 110, a perimeter channel 190 is formed around the perimeter of the IGU 120 between it and the window frame 110. Looking down into the perimeter channel 190, the interior sealant tape 150 may currently still be seen.

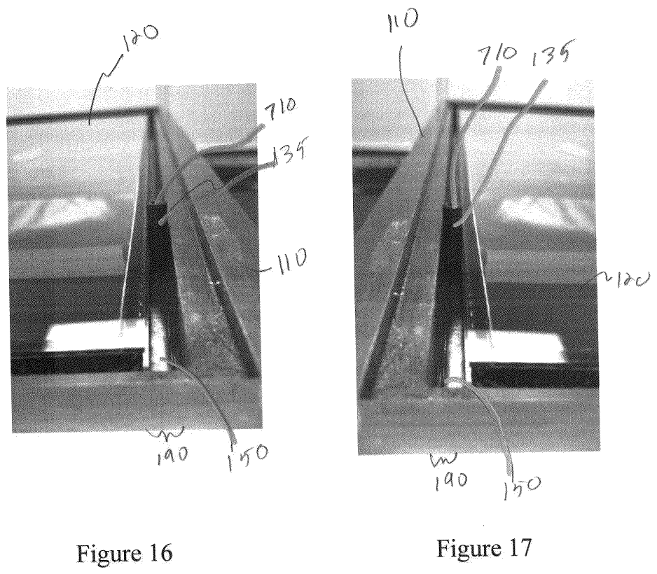

FIG. 16 shows a perspective view down a first side of the perimeter channel 190 showing a first gas transit nozzle 135. FIG. 16 shows the first gas transit nozzle 135 positioned in the perimeter channel 190 with the service aperture 710 vertically upward toward the interior of the window frame 110. As shown in FIG. 16, the upper most vertical extend of the first gas transit nozzle 135 exceeds the uppermost vertical extent of the IGU 120, which is substantially the same as the uppermost vertical extent of the window frame 110. However, once the IGU 120 is positioned in the window frame 110, the top portion of the first gas transit nozzle 135 is cut off so that the uppermost vertical extent of the first gas transit nozzle 135 is approximately the same as that of the IGU 120 and window frame 110.

FIG. 17 shows a perspective view down a second, opposite side of the perimeter channel 190 showing a second gas transit nozzle 135. Similar to FIG. 16, the second gas transit nozzle 135 is positioned in the perimeter channel 190 with its service aperture 710 vertically upward toward the interior of the window frame 110. Also, as discussed above in FIG. 16, the top portion of the second gas transit nozzle 135 will be cut off so that the uppermost vertical extent of the first gas transit nozzle 135 is approximately the same as that of the IGU 120 and window frame 110.

In one embodiment, the first gas transit nozzle and second gas transit nozzle are used in conjunction so that one gas transit nozzle supplies gas into the interior cavity while the other gas transit nozzle allows gas to flow out of the interior cavity. In one embodiment, the gas transit nozzles may be composed of rubber of plastic with an interior passageway that opens as a gas injector is introduced into the service aperture of the gas transit nozzle so as to allow gas to flow through the gas transit nozzle. Conversely, when the gas injector is removed from the service aperture, the interior passageway of the gas transit nozzle closes or reseals to prevent gas from flowing through the gas transit nozzle. Alternatively, the gas nozzles may be made from metal such as aluminum. Alternatively, the gas nozzle may be a plastic outer shell with a rubber interior of a combination of metal, rubber, or plastic.

Additionally, the first and second gas transit nozzles may be located anywhere around the perimeter of the IGU 120. FIGS. 16 and 17 show the first and second gas transit nozzles located on opposite sides of the IGU 120, but they may alternatively be positioned on the top and bottom, diagonally one on a side and one on a top or bottom, or may both be positioned on one side of the IGU 120.

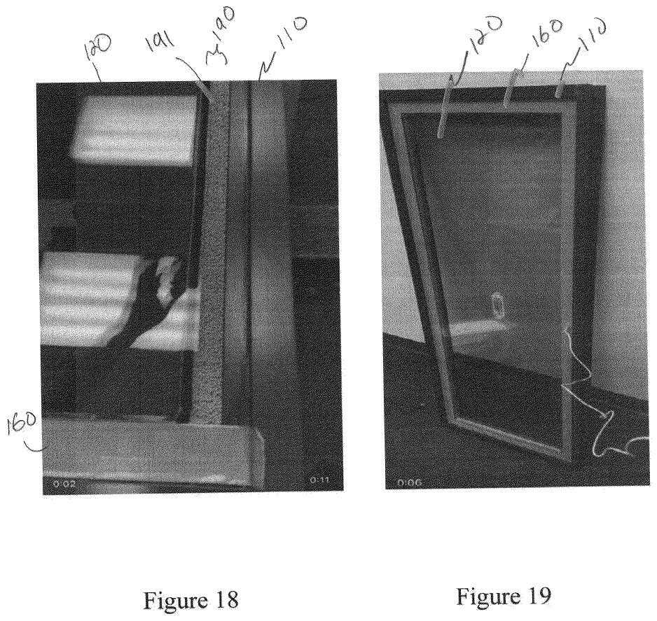

FIG. 18 illustrates the installation of the desiccant in the perimeter channel 190 and the partial installation of the exterior sealant tape 160. As shown in FIG. 18, the perimeter channel 190 has been filled with a desiccant 191 to a height approximately that of the IGU 120, window frame 110, and gas transit nozzle 135. Once the desiccant 191 has been installed, the exterior sealant tape 160 is positioned over the desiccant and perimeter channel 190 to hold the desiccant in the perimeter channel 190. As shown in FIG. 18, the exterior sealant tape 160 is adhered near the perimeter of the IGU 120 and then extends to the interior side of the window frame 110 where it is also adhered.

In one embodiment, the perimeter channel 190 is filled with moisture absorbents/desiccant materials, such as silica gel or molecular sieves, to maintain dry conditions and prevent condensation.

In one embodiment, the exterior sealant tape 160 seals the service apertures of the gas transit nozzles 135

FIG. 19 illustrates the complete installation of the exterior sealant tape 160. As shown in FIG. 19, the exterior sealant tape 160 has been installed over the entire perimeter channel 190 to seal the desiccant 191 in the perimeter channel 190. However, as further discussed herein, the sealant tape 160 is removable so that the retrofit cavity system 100 is serviceable. First, the sealant tape 160 may be removed to expose the service aperture of the one or more gas transit nozzles 135. Gas may then be either removed from the interior cavity 101 using the gas transit nozzles and/or added to the interior cavity 101. Additionally, the exterior sealant tape 160 may be removed so that the desiccant may be replaced. Alternatively, instead of removing the exterior sealant tape 160, a gas injector may be pierced or poked directly through the exterior sealant tape 160 and into the service aperture of the gas transit nozzles 135 at the locations where the gas transit nozzles 135 are placed.

At this point in the assembly of the serviceable retrofit cavity system 100, the final finishing trim 170 may be installed as discussed below. Additionally, gas replacement in the interior cavity 101 between the glass pane 112 and the IGU 120 may be performed, for example to reduce or eliminate moisture. Additionally, moisture may be reduced by absorption into the desiccant materials 191 or the glass-IGU spacer 130, especially if the glass-IGU spacer 130 is a Super Spacer®. In one embodiment, the gas transit nozzles 135 or piped are for security or servicing purposes in case any condensation accumulates in the interior cavity 101 due to moisture. Such moisture may then be removed through the gas transit nozzles to exchange the moist air with dry air and/or gas.

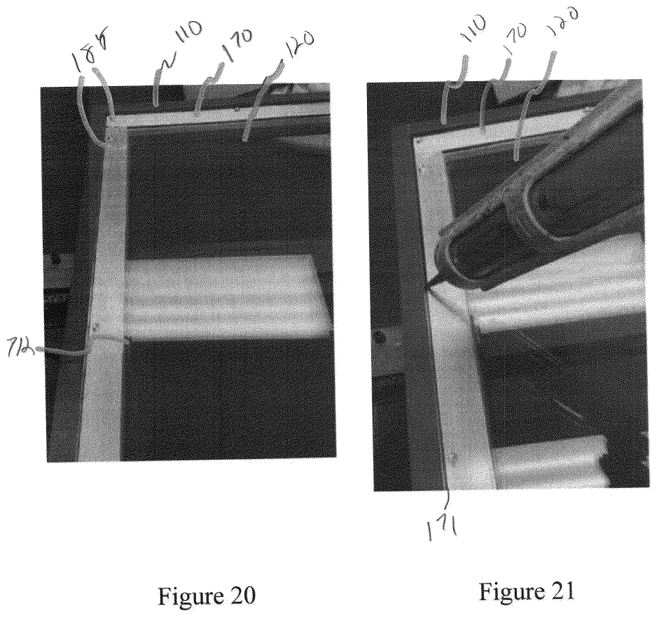

FIG. 20 illustrates the interior side of the retrofit cavity system 100 with the finishing trim 170 installed. As shown in FIG. 20, the finishing trim 170 is positioned over the exterior sealant tape 160. The finishing trim 170 includes pre-drilled holes for accepting the mounting screws 185. The mounting screws 185 may then be installed through the finishing trim 170 and threadedly engage with the window frame 110 to attach the finishing trim 170 to the window frame 110. The cavity aperture 712 of the gas transit nozzle 135 extending into the interior cavity 101 may also be seen.

As shown in FIG. 20, the finishing trim 170 may be composed of a set of four flat pieces. In an alternative embodiment, the finishing trim 170 may be composed of a single, flat rectangular piece. In one embodiment, the finishing trim 170 is made of aluminum or composites.

FIG. 21 illustrates the interior side of the retrofit cavity system 100 with finishing trim sealant 171 being applied. As shown in FIG. 21, the finishing trim sealant 171 is applied at the junction, corner, or intersection between the finishing trim 170 and the window frame 110. The finishing trim sealant 171 is preferably a liquid rubber or butyl or hybrid sealant that is applied to make the junction airtight.

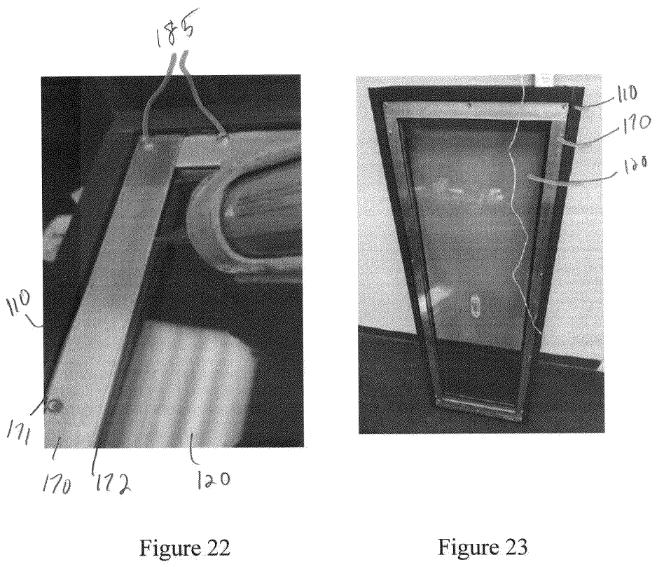

FIG. 22 illustrates the interior side of the retrofit cavity system 100 with an optional IGU-finishing trim sealant 172 being applied. As shown in FIG. 22, the optional IGU-finishing trim sealant 172 is applied at the junction, corner, or intersection between the finishing trim 170 and the glass panel of the IGU 120. The IGU-finishing trim sealant 172 is preferably a liquid rubber or butyl or hybrid sealant that is applied to make the junction airtight.

FIG. 23 illustrates the interior side of the fully assembled retrofit cavity system 100. FIG. 23 shows the glass panel of the IGU 120, the window frame 110, and the finishing trim 170.

In one embodiment, the thickness of the first of the glass panels or panes of the IGU 120 may be ⅛ of an inch, the thickness of the second of the glass panels of the IGU 120 may be ⅛ of an inch, the space between the first and second panels of the IGU 120 may be 7/16 of an inch, the thickness of the preexisting glass pane may be 3/16 of an inch, and the thickness of the interior cavity may be ⅝ of an inch. However, all of the thicknesses may vary depending on desired design parameters, such as greater insulation, which may result in increased thicknesses for any or any combination of the above dimensions.

Additionally, the thickness of the interior cavity 101 may vary depending on the thickness of the window frame 110. Additionally, the width of the perimeter channel may vary, but may be 1.5 inches in one embodiment.

In one embodiment, the serviceable retrofit cavity system with active gas management is serviceable because the gas in the interior cavity may be replaced and/or the desiccant may be replaced. Similarly, the system may be described as active gas management because the gas in the interior cavity may be replaced or altered after installation through the gas transit nozzle 135. This contrasts with sealed systems that may include gas, but are sealed during manufacture and thus do not allow active management of the gas while the system is installed.

The serviceable retrofit cavity system with active gas management 100 represents an innovative enhancement for existing aluminum-framed windows with single-pane glass. This system incorporates an external thermal-insulated glass unit (IGU), securely attached to the interior side of the original single-pane configuration, effectively transforming it into a triple-pane glass unit.

Some advantages of the retrofit cavity system 100 include: 1. The existing single-pane glass remains within its aluminum frame. An additional thermal-insulated glass unit is mounted internally, creating a composite structure that mimics the performance of triple-glazed windows. 2. A glass-IGU spacer 130 connects the original single pane to the new IGU. The spacer is secured using butyl sealants to ensure an airtight bond. This prevents thermal bridging and provides structural integrity. 3. Two L-shaped nozzles are integrated into the spacer, positioned between the single-pane glass and the thermal-insulated unit. The nozzles have an inlet positioned level with the thickness of the interior surface of the IGU and accessible from the interior of the window system. The nozzles have an outlet positioned into a chamber located between the inner surface of the pre-existing glass pane and the outward-facing surface of the exterior pane of the IGU. These nozzles, which can be placed at any point along the spacer's perimeter including the sides, top and bottom, serve distinct purposes: the Injection Nozzle allows the introduction of insulating gases such as argon, krypton, or dry air into the chamber while the Exhaust/Pump Nozzle: Facilitates the evacuation of air or gases from the chamber during the filling process. The nozzles extend from the space between the glass panes into the internal trim, which also supports the new IGU. 4. A channel is created around the perimeter between the new IGU and the original aluminum frame. This channel serves multiple purposes: a) Ensures no direct contact between the new glass unit and the aluminum frame, preventing thermal conductivity. b) Provides space for the nozzles and additional components. and c) Houses desiccant materials, such as silica gel or molecular sieves, to maintain dry conditions and prevent condensation. Additionally, one or more rubber or plastic spacer blocks may be placed between the bottom edge of the IGU and the top edge of the pre-existing window frame to help support the weight of the IGU. 5. After the installation of the desiccant, the channel is sealed with butyl tape extending from the edge of the aluminum frame to the edge of the IGU. Finally, an aluminum or composite trim is installed over the sealed edge. This trim is secured with screws to protect the seal and provide a clean, finished appearance.

The retrofit cavity system 100 is designed to enhance thermal performance, reduce condensation, and improve energy efficiency without requiring the replacement of the original window frame.

For example, thermal performance is increased because the pre-existing single-pane window is transformed into effectively a triple-pane window, which acts to decrease the heat loss through the window. Additionally, there are no additional metal or conductive components extending between the pre-existing single-pane window into the interior of the window system.

The system also greatly increases the sun-proofing of the window by reducing the amount of infrared light that is transmitted into the interior because the light must be transmitted through three panes of glass.

The system also greatly increased sound proofing by reducing the total sound transfer through the system by moving from a single-pane window to a three-pane window system.

Additionally, condensation is reduced because the nozzles allow the air in the channel between the pre-existing single pane and installed IGU to be replaced by dry air or stable gasses such as argon or krypton. Additionally, the spacer has been chosen to be moisture absorber at lower temperatures. Additionally, surrounding the IGU with a desiccant that is moisture-absorbing additionally keeps the air dry. Finally, in the event a leak develops, the nozzles may later be accessed to pump out the moisture and add additional dry air or stable gasses and may then be re-sealed.

The retrofit cavity system 100 is not limited to aluminum windows with a single glass panel or pane only. In other embodiments, the system may be employed with other metals such as steel or may be employed with other materials such as wood or plastic. Additionally, the original window may be a double or triple pane window. Alternatively, when the original window is a double or triple pane window, the IGU may be replaced by a single additional pane instead of a multi-pane IGU. It can be used in a variety of applications where its purpose can be useful and applicable. That includes but is not limited to all the windows made of frame material different than aluminum with existing glass panels different than single pane.

In one embodiment of retrofit cavity system 100, the retrofit panes including the IGU 120 are easily removable, replaceable, and repairable if needed. For example, the IGU 120 may be removed by first removing the finishing trim 170 and then removing the exterior sealant tape 160. The desiccant 191 may be removed from the perimeter channel 190 to expose the interior sealant tape 150. A cutting tool such as an L-shaped knife or wire cutting filament may then be introduced near the juncture of the interior sealant tape 150 and glass-IGU spacer 130 to cut through the interior sealant tape 150. Once the interior sealant tape 150 is cut, the IGU 120 and attached glass-IGU spacer 130 may be removed, repaired, replaced, and/or reinstalled.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A retrofit cavity system for installation in a window frame having a glass pane, said system including:
an Insulated Glass Unit (IGU) including an exterior-facing glass pane, an interior-facing glass pane and a spacer separating said glass panes;
a glass-IGU spacer adhered along a first side near the perimeter of said exterior-facing glass pane of said IGU; and
a gas transit nozzle extending though said glass-IGU spacer and including a cavity aperture positioned inside a perimeter described by said glass-IGU spacer and a service aperture positioned proximal to said interior-facing glass pane of said IGU,
wherein a second side of said glass-IGU spacer is adhered to said glass pane of said window frame to describe an interior cavity between said glass pane of said window frame, said exterior-facing glass pane of said IGU and said perimeter described by said glass-IGU spacer,
wherein gas is moveable into or out of said interior cavity through said gas transit nozzle.

2. The system of claim 1 further including interior sealant tape positioned around the interior perimeter of said glass pane of said window frame.

3. The system of claim 2 wherein said second side of said glass-IGU spacer is adhered to said glass pane using said interior sealant tape.

4. The system of claim 1 wherein said IGU is lesser in height and width than the interior height and width of said window frame so that a perimeter channel is formed around the perimeter of said IGU.

5. The system of claim 4 wherein said gas transit nozzle extends through said perimeter channel.

6. The system of claim 4 wherein said perimeter channel includes a desiccant.

7. The system of claim 6 where an exterior sealant tape is positioned over said perimeter channel and adhered to said interior-facing glass pane of said IGU and said window frame.

8. The system of claim 7 where a finishing trim is positioned over said exterior sealant tape.

9. The system of claim of claim 8 wherein said finishing trim is attached to said window frame.

10. The system of claim 1 including a plurality of gas transit nozzles.

11. A method for installing a retrofit cavity system in a window frame having a glass pane, said method including:
adhering an Insulated Glass Unit (IGU) to an glass-IGU spacer,
wherein said Insulated Glass Unit (IGU) includes an exterior-facing glass pane, an interior-facing glass pane and a spacer separating said glass panes,
wherein said glass-IGU spacer is adhered along a first side near the perimeter of said exterior-facing glass pane of said IGU,
wherein a gas transit nozzle extends though said glass-IGU spacer and includes a cavity aperture positioned inside a perimeter described by said glass-IGU spacer and a service aperture positioned proximal to said interior-facing glass pane of said IGU; and
adhering a second side of said glass-IGU spacer to said glass pane of said window frame to describe an interior cavity between said glass pane of said window frame, said exterior-facing glass pane of said IGU and said perimeter described by said glass-IGU spacer,
wherein gas is moveable into or out of said interior cavity through said gas transit nozzle.

12. The method of claim 11 wherein interior sealant tape positioned around the interior perimeter of said glass pane of said window frame.

13. The method of claim 12 wherein said second side of said glass-IGU spacer is adhered to said glass pane using said interior sealant tape.

14. The method of claim 11 wherein said IGU is lesser in height and width than the interior height and width of said window frame so that a perimeter channel is formed around the perimeter of said IGU.

15. The method of claim 14 wherein said gas transit nozzle extends through said perimeter channel.

16. The method of claim 14 wherein said perimeter channel includes a desiccant.

17. The method of claim 16 further including positioning an exterior sealant tape over said perimeter channel and adhering said exterior sealant tape to said interior-facing glass pane of said IGU and said window frame.

18. The method of claim 17 further including positioning a finishing trim over said exterior sealant tape.

19. The method of claim of claim 18 further including attaching said finishing trim to said window frame.

20. The method of claim 11 including a plurality of gas transit nozzles.
